(19) United States
(12) Patent Application Publication
(10) Pub. No.: US 2020/0309551 A1
(43) Pub. Date: Oct. 1, 2020

(54) SYSTEMS AND METHODS FOR VEHICLE SHARING SERVICES

(71) Applicant: BEIJING QISHENG SCIENCE AND TECHNOLOGY CO., LTD., Beijing (CN)

(72) Inventor: Mingzhu YANG, Hangzhou (CN)

(73) Assignee: BEIJING QISHENG SCIENCE AND TECHNOLOGY CO., LTD., Beijing (CN)

(21) Appl. No.: 16/901,565

(22) Filed: Jun. 15, 2020

Related U.S. Application Data
(63) Continuation of application No. PCT/CN2018/112360, filed on Oct. 29, 2018.

(30) Foreign Application Priority Data
Dec. 15, 2017 (CN) 201711350446.7

(51) Int. Cl. G01C 21/34; G07C 9/00; G06Q 10/02; G08G 1/00

(52) U.S. Cl. CPC G01C 21/3438; G07C 9/00309; G07C 2009/00436; G08G 1/205; G07C 2009/00539; G06Q 10/02

(57) ABSTRACT

The present disclosure is related to systems and methods for operating a lock in a vehicle. The method includes obtaining and verifying a request to use a vehicle, if the request to use the vehicle satisfies a condition for using the vehicle, open a lock of the vehicle. The method also includes obtaining a request to temporarily close the lock of the vehicle, close the lock of the vehicle. The method further includes obtaining a request to abort the request to temporarily close the lock of the vehicle, open the lock of the vehicle. The method still further includes obtaining and verifying a request to return the vehicle, if the request to return the vehicle satisfies a condition for returning the vehicle, close the lock of the vehicle.

### CROSS-REFERENCE TO RELATED APPLICATIONS

This application is a Continuation of International Application No. PCT/CN2018/112360 filed on Oct. 29, 2018, which claims priority to Chinese Patent Application No. 201711350446.7 filed on Dec. 15, 2017. The contents of the above applications are incorporated herein by reference in their entirety.

### TECHNICAL FIELD

The present disclosure generally relates to vehicle sharing service platforms, and more particularly, to systems and methods for providing vehicle service to users and billing the users in the vehicle sharing service system.

### BACKGROUND

Recently, sharing vehicles have become increasingly popular. Through a vehicle sharing service platform, a user may borrow (or rent) and return a vehicle through an application installed in a user equipment, such as a smartphone terminal. In some scenarios, the user may need to leave the vehicle for a while and then come back to continue to use the vehicle. Instead of returning the vehicle, the user may need to temporarily lock the vehicle. Thus, it may be desirable to develop systems and methods for providing vehicle service to users conveniently.

### SUMMARY

According to an aspect of the present disclosure, a system for operating a lock in a vehicle including at least one information exchange port configured to communicate with at least one user terminal via a network and in communication with at least one vehicle registered with the system via a network, at least one non-transitory storage medium including a set of instructions, and at least one processor in communication with the at least one information exchange port and the at least one non-transitory storage medium. When executing the set of instructions, the at least one processor may be directed to operate logic circuits in the at least one processor to establish a first wireless communication with a user terminal and a second wireless communication with a lock mounted on the vehicle registered with the system. The at least one processor may be directed to operate the logic circuits to obtain, from the user terminal, a primary request signal related to use of the vehicle by a user associated with the user terminal, wherein the primary request signal includes identifier data of the user terminal. The at least one processor may be directed to operate the logic circuits to obtain identifier data of the vehicle. The at least one processor may be directed to operate the logic circuits to determine a primary authorization command based on the identifier data of the user and the identifier data of the vehicle, and create a record of a mission to authorize the user to use the vehicle in the at least one non-transitory storage medium. The at least one processor may be directed to operate the logic circuits to send a primary enabling signal to the vehicle to open a lock mounted on the vehicle based on the primary authorization command. The at least one processor may be directed to operate the logic circuits to obtain, from the user terminal, a first secondary request signal including a temporary locking signal. The at least one processor may be directed to operate the logic circuits to determine a secondary disabling signal to lock the lock of the vehicle without terminating the mission stored in the at least one non-transitory storage medium based on the first secondary request signal.

In some embodiments, the at least one processor may be directed to operate the logic circuits to obtain, from the user terminal, a second secondary request signal including a temporary unlocking signal. The at least one processor may be directed to operate the logic circuits to determine, based on the second secondary request signal, a secondary enabling signal to unlock the lock and resume the mission stored in the at least one non-transitory storage medium. The at least one processor may be directed to operate the logic circuits to determine, based on an aborting signal sent from the user terminal, a primary disabling signal to lock the vehicle to disable the use of the vehicle. The at least one processor may be directed to operate the logic circuits to terminate and release the mission stored in the at least one non-transitory storage medium in response to the primary disabling signal.

In some embodiments, the primary request signal may further include the identifier data of the vehicle. The identifier data of the vehicle may be obtained based on a quick-response code of the vehicle.

In some embodiments, the vehicle may include a reminding signal generator. The secondary disabling signal may further be configured to operate the reminding signal generator to generate a reminding signal related to a temporary locking status of the vehicle.

In some embodiments, the vehicle may include a reminding signal generator. The secondary enabling signal may further be configured to operate the reminding signal generator to generate a reminding signal related to an unlocking status of the vehicle.

In some embodiments, the reminding signal generator may include a light-emitting diode.

In some embodiments, the at least one processor may be directed to operate the logic circuits to determine a secondary authorization command based on the first secondary request signal and the primary authorization command. The at least one processor may be directed to operate the logic circuits to determine the secondary disabling signal based on the secondary authorization command.

In some embodiments, the at least one processor may be directed to operate the logic circuits to determine a secondary authorization command based on the second secondary request signal and the primary authorization command. The at least one processor may be directed to operate the logic circuits to determine the secondary enabling signal based on the secondary authorization command.

According to another aspect of the present disclosure, a system for determining a cost related to use of a vehicle including at least one information exchange port in communication with at least one user terminal via a network and in communication with at least one vehicle registered with the system via a network, at least one non-transitory storage medium including a set of instructions, and at least one processor in communication with the at least one non-transitory storage medium. When executing the set of instructions, the at least one processor may be directed to operate logic circuits in the at least one processor to obtain, from a user terminal of the at least one user terminal, a primary request signal related to a mission to use of a vehicle registered with the system, wherein the primary request signal includes identifier data of the user. The at least one processor may be directed to operate the logic circuits to generate a user interface to display a cost of the mission on the user terminal via the at least one information exchange port. The at least one processor may be directed to operate the logic circuits to determine, based on the primary request signal send from the user terminal, a first location where a lock mounted on the vehicle is unlocked based on the primary request signal. The at least one processor may be directed to operate the logic circuits to determine, based on secondary request signals sent from the user terminal, a second location where the lock of the vehicle is temporarily locked to temporarily disable the use of the vehicle at the second location and then is unlocked to resume the use of the vehicle at the second location. The at least one processor may be directed to operate the logic circuits to determine, based on an aborting signal sent from the user terminal, a third location where the lock of the vehicle is locked to terminate the mission to user the vehicle at the third location. The at least one processor may be directed to operate the logic circuits to determine a first cost related to the first location and the second location. The at least one processor may be directed to operate the logic circuits to determine a second cost related to the secondary request signal. The at least one processor may be directed to operate the logic circuits to determine a third cost related to the second location and the third location. The at least one processor may be directed to operate the logic circuits to determine a sum cost based on the first cost, the second cost and the third cost. The at least one processor may be directed to operate the logic circuits to display an indicator related to the sum cost on a user interface of the user terminal.

In some embodiments, the at least one processor may be directed to operate the logic circuits to determine the second cost related to the secondary request signal based on temporal information of the secondary request signal.

According to another aspect of the present disclosure, a method implemented on at least one device each of which has at least one information exchange port in communication with at least one user terminal via a network and in communication with at least one vehicle registered with the system via a network, at least one non-transitory storage medium including a set of instructions, and at least one processor in communication with the at least one non-transitory storage medium. The method may include establishing a first wireless communication with a user terminal and a second wireless communication with a lock mounted on the vehicle registered with the system. The method may also include obtaining, from the user terminal, a primary request signal related to use of the vehicle by a user associated with the user terminal, wherein the primary request signal includes identifier data of the user terminal. The method may also include obtaining identifier data of the vehicle. The method may also include determining a primary authorization command based on the identifier data of the user and the identifier data of the vehicle, and create a record of a mission to authorize the user to use the vehicle in the at least one non-transitory storage medium. The method may also include based on the primary authorization command, sending a primary enabling signal to the vehicle to open a lock mounted on the vehicle. The method may further include obtaining, from the user terminal, a first secondary request signal including a temporary locking signal. The method may still further include based on the first secondary request signal, determining a secondary disabling signal to lock the lock of the vehicle without terminating the mission stored in the at least one non-transitory storage medium.

According to another aspect of the present disclosure, a method implemented on at least one device each of which has at least one information exchange port in communication with at least one user terminal via a network and in communication with at least one vehicle registered with the system via a network, at least one non-transitory storage medium including a set of instructions, and at least one processor in communication with the at least one non-transitory storage medium. The method may include obtaining, from a user terminal of the at least one user terminal, a primary request signal related to a mission to use of a vehicle registered with the system, wherein the primary request signal includes identifier data of the user. The method may also include generating a user interface to display a cost of the mission on the user terminal via the at least one information exchange port. The method may also include based on the primary request signal send from the user terminal, determining a first location where a lock mounted on the vehicle is unlocked based on the primary request signal. The method may also include based on secondary request signals sent from the user terminal, determining a second location where the lock of the vehicle is temporarily locked to temporarily disable the use of the vehicle at the second location and then is unlocked to resume the use of the vehicle at the second location. The method may also include based on an aborting signal sent from the user terminal, determining a third location where the lock of the vehicle is locked to terminate the mission to user the vehicle at the third location. The method may also include determining a first cost related to the first location and the second location. The method may also include determining a second cost related to the secondary request signal. The method may further include determining a third cost related to the second location and the third location. The method may also include determining a sum cost based on the first cost, the second cost and the third cost. The method may still further include displaying an indicator related to the sum cost on a user interface of the user terminal.

According to still another aspect of the present disclosure, a non-transitory computer readable medium embodying a computer program product, the computer program product comprising instructions configured to cause a computing device to perform a method. The method may include establishing a first wireless communication with a user terminal and a second wireless communication with a lock mounted on the vehicle registered with the system. The method may also include obtaining, from the user terminal, a primary request signal related to use of the vehicle by a user associated with the user terminal, wherein the primary request signal includes identifier data of the user terminal. The method may also include obtaining identifier data of the vehicle. The method may also include determining a primary authorization command based on the identifier data of the user and the identifier data of the vehicle, and create a record of a mission to authorize the user to use the vehicle in the at least one non-transitory storage medium. The method may also include based on the primary authorization command, sending a primary enabling signal to the vehicle to open a lock mounted on the vehicle. The method may further include obtaining, from the user terminal, a first secondary request signal including a temporary locking signal. The method may still further include based on the first secondary request signal, determining a secondary disabling signal to lock the lock of the vehicle without terminating the mission stored in the at least one non-transitory storage medium.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary vehicle sharing service system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device according to some embodiments of the present disclosure;

FIG. 4 is a block diagram illustrating an exemplary processing engine according to some embodiments of the present disclosure;

FIG. 5 is a block diagram illustrating an exemplary lock module according to some embodiments of the present disclosure;

FIG. 6 is a block diagram illustrating an exemplary location module and an exemplary cost module according to some embodiments of the present disclosure;

FIG. 7 is a flowchart illustrating an exemplary process for providing vehicle service to a user according to some embodiments of the present disclosure;

FIG. 8 is a flowchart illustrating an exemplary process for billing users in the vehicle sharing system according to some embodiments of the present disclosure;

FIG. 9 is a flowchart illustrating an exemplary process for providing vehicle service to a user according to some embodiments of the present disclosure; and

FIG. 10 is a flowchart illustrating an exemplary process for billing users in the vehicle sharing system according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is to describe particular exemplary embodiments only and is not intended to be limiting. As used herein, the singular forms “a,” “an,” and “the” may be intended to include the plural forms as well, unless the context expressly indicates otherwise. It will be further understood that the terms “comprise,” “comprises,” and/or “comprising,” “include,” “includes,” and/or “including,” when used in the present disclosure, specify the presence of stated features, integers, steps, operation, elements, and/or components, but do not preclude the presence or addition of one or more other features, integers, steps, operation, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of the present disclosure. It is to be expressly understood, however, that the drawings are for illustration and description only, and are not intended to limit the scope of the present disclosure. It is understood that the drawings are not to scale.

It will be understood that the term “system,” “engine,” “unit,” and/or “module” used herein are one method to distinguish different components, elements, parts, sections, or assemblies of different levels in ascending order. However, the terms may be displaced by other expressions if they achieve the same purpose.

It will be understood that when a unit, engine, or module is referred to as being “on,” “connected to,” or “coupled to,” another unit, engine, or module, it may be directly on, connected or coupled to, or communicate with the other unit, engine, or module, or an intervening unit, engine, or module may be present, unless the context clearly indicates otherwise. As used herein, the term “and/or” includes any and all combinations of one or more of the associated listed items.

The flowcharts used in the present disclosure illustrate operation that systems implement according to some embodiments of the present disclosure. It is to be expressly understood, the operation of the flowcharts may be implemented not in order. Conversely, the operation may be implemented in inverted order, or simultaneously. Moreover, one or more other operations may be added to the flowcharts. One or more operations may be omitted from the flowcharts.

Moreover, while the systems and methods described in the present disclosure are described primarily regarding a vehicle sharing service, it should also be understood that they are merely exemplary embodiments. The systems or methods described in the present disclosure may apply to any other kind of economic sharing service that transfers a usufruct from one to another in an online rental transaction. For example, the systems or methods of the present disclosure may apply to physical asset renting and/or a labor service. The physical asset may include real estate (e.g., a hotel, a room, or an apartment), vehicles (e.g., a car, a bicycle, an electric bicycle, a bus, a hot-air balloon, or an airplane), goods (e.g., clothes, an umbrella, a charger, or a microphone), etc. The labor service may include pet adoption, housekeeping, designated driving, etc. The application of the systems or methods of the present disclosure may include a web page, a plug-in for a browser, a client terminal, a custom system, an internal analysis system, an artificial intelligence robot, or the like, or any combination thereof.

The terms “cyclist,” “requestor,” “service requestor,” “cyclist terminal,” “requestor terminal,” and “user” in the present disclosure are used interchangeably to refer to an individual, an entity, or a tool that may request or order a bicycle sharing service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

It should be noted that the vehicle sharing service is a new form of service rooted only in post-Internet era. It provides technical solutions to users and service providers that could raise only in the post-Internet era. In the pre-Internet era, when a user needs to rent a vehicle in a vehicle rental shop, the vehicle request and acceptance occur only between the user and a shopkeeper of the vehicle rental shop who meet each other at a physical place. Through the Internet (and/or other types of network technology like Bluetooth), the vehicle sharing service, however, allows a user of the service to acquire a location of a vehicle accurately and rent a vehicle anywhere and anytime. It also allows the user to park the vehicle in any area where the parking of the vehicle is allowed. Therefore, through the Internet, a vehicle sharing system may provide a more convenient transaction platform for users and service providers that may never meet in the settings of the traditional, pre-Internet vehicle service.

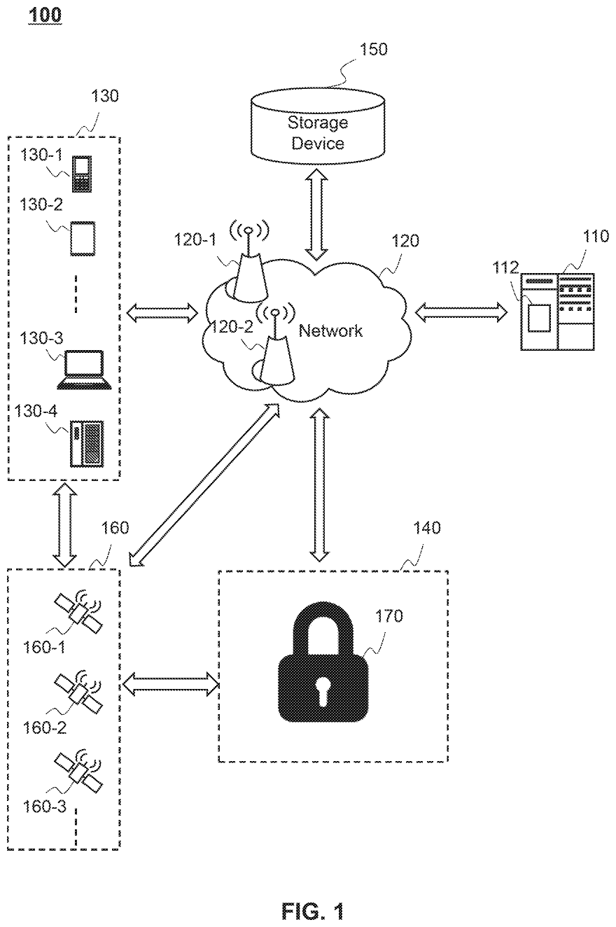

FIG. 1 is a schematic diagram illustrating an exemplary vehicle sharing system 100 according to some embodiments of the present disclosure. The vehicle sharing system 100 may include one or more servers 110, one or more networks 120, one or more user terminals 130 registered with the server 110 to have identifier data saved therein, a vehicle 140, a storage device 150, a positioning device 160, and a lock 170. The vehicle sharing system 100 may lock or unlock the vehicle 140 via the lock 170 through the methods disclosed in the present disclosure. In some embodiments, the vehicle 140 may be one or more bicycles, one or more electric bicycles, one or more motorcycles, one or more cars, and any other types of vehicles suitable for commercial sharing and registered with the server 110 to have identifier data saved therein. The vehicle sharing system 100 may provide bicycle sharing service to a user. In some embodiments, the user may need to temporarily leave the vehicle and will come back to continue to use the vehicle. The vehicle sharing system 100 may temporarily lock the vehicle for a while and allow the user to maintain control of the vehicle. In some embodiments, the vehicle sharing system 100 may bill the user according to a ride status of the vehicle when the user rides the vehicle. The vehicle sharing system 100 may further bill the user according to a temporarily locked status of the vehicle when the user temporarily lock the vehicle. In some embodiments, the vehicle sharing system 100 may bill the user based on a ride status of the bicycle and a temporarily locked status of the bicycle.

The server 110 may communicate with the user terminal 130, the vehicle 140, and/or the lock 170 to provide various functionalities of the vehicle sharing service. For example, the server 110 may receive a service request from the user terminal 130 via, for example, the network 120. For example, the server 110 may receive a request to use a vehicle, a request to temporarily close a lock of a vehicle, a request to abort a request to temporarily close a lock of a vehicle, and a request to return a vehicle, from the user terminal 130 via, for example, the network 120. In some embodiments, the vehicle 140 may be a bicycle. The service request may include a request to use a bicycle, a request to temporarily close a lock of a bicycle, a request to abort a request to temporarily close a lock of a bicycle, and a request to return a bicycle. The service request may include information relating to the ride and/or the vehicle 140, including, for example, a vehicle type, a departing place, a destination, mileage, a time when the vehicle is temporarily locked, a route, or the like, or any combination thereof. The service request may also include information relating the user (e.g., the user account information) and/or the user terminal 130 (e.g., the location of the user terminal 130).

The server 110 may also transmit information to the user terminal 130, the vehicle 140, and/or the lock 170. For example, the server 110 may transmit to a vehicle 140 an instruction to close (or temporarily close) a lock of the vehicle 140, an instruction to open a lock of the vehicle 140, and/or the information related to the vehicle 140 (e.g., the information indicating that whether a lock of the vehicle is closed (or temporarily closed).

In some embodiments, the server 110 may be a single server or a server group. The server group may be a centralized server group connected to the network 120 via an access point or a distributed server group connected to the network 120 via one or more access points, respectively. In some embodiments, the server 110 may be locally connected to the network 120 or in remote connection with the network 120. For example, the server 110 may access information and/or data stored in the user terminal 130, the vehicle 140, and/or the storage device 150 via the network 120. As another example, the storage device 150 may serve as backend data storage of the server 110. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the server 110 may include a processing engine 112. The processing engine 112 may process information and/or data related to performing one or more functions in the present disclosure. For example, the processing engine 112 may process operation information of a lock to determine the status of the lock. In some embodiments, the processing engine 112 may include one or more processing units (e.g., single-core processing engine(s) or multi-core processing engine(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the vehicle sharing system 100 (e.g., the server 110, the user terminal 130, the vehicle 140, the storage device 150, or the lock 170) may transmit information and/or data to another component(s) in the vehicle sharing system 100 via the network 120. For example, the server 110 may access and/or obtain data of a plurality of vehicles 140 from the storage device 150 via the network 120. In some embodiments, the server 110 may transmit a command to close (or temporarily close) a lock of the vehicle 140 based on the service request from the user terminal 130. In some embodiments, the positioning device 160 may transmit location information to the user terminal 130 via the network 120.

In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the vehicle sharing system 100 may be connected to the network 120 to exchange data and/or information.

In some embodiments, a user may be an owner of the user terminal 130. The user terminal 130 may receive input from the user and transmit the information relating to the input to the server 110 via the network 120. The user terminal 130 may also receive information from the server 110 via the network 120. For example, the user terminal 130 may receive input from the user relating to a service request for a vehicle to the server 110, receive a service confirmation, and/or information or instructions from the server 110. Merely by way of example, the user terminal 130 may be configured to transmit a service request to the server 110 to temporarily close the lock of the vehicle 140.

In some embodiments, the user terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glass, a smart helmet, a smart watch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include a built-in computer, a built-in onboard television, a built-in tablet, etc. In some embodiments, the user terminal 130 may include a signal transmitter and a signal receiver configured to communicate with the positioning device 160 for locating the position of the user and/or the user terminal 130.

In some embodiments, the vehicle 140 may be a bicycle. The bicycle may be any type of bicycle including, for example, a unicycle, a bicycle, a tricycle, a tandem, a motor bicycle, an electric bicycle, a moped, etc. In some embodiments, the bicycle may include the lock 170. In some embodiments, the vehicle 140 and/or the lock 170 may be identified with a unique symbol. The unique symbol may include a bar code, a quick response (QR) code, a serial number including letters and/or digits, or the like, or any combination thereof. For example, the identification (ID) of the vehicle 140 may be obtained by scanning the QR code of the vehicle 140 through a mobile application of the user terminal 130. As another example, the identification (ID) of the vehicle 140 may be obtained by scanning the QR code of the vehicle 140 through a camera of an iPhone.

The storage device 150 may store data and/or instructions. The data may include data related to users, user terminals 130, vehicles 140, etc. For example, the vehicle 140 may be a bicycle. The data related to the users may include user profiles including for example, names of the users, mobile numbers of the users, ID numbers of the users, types of the users (e.g., annual card users, quarterly card users, or monthly card users), usage records of the users (e.g., riding time, riding miles, temporarily locked time), credit rating of the users, historical routes, account balance, etc. The data related to the vehicles 140 may include service conditions of the vehicles (e.g., an available status, a temporarily locked status, an end temporarily locked status, on a ride, in a maintenance status), positions of the vehicles, types of the vehicles (e.g., a unicycle, a bicycle, a tricycle, a tandem, a motor bicycle, an electric bicycle), etc. In some embodiments, the storage device 150 may store data obtained from the user terminal 130 and/or the vehicle 140. For example, the storage device 150 may store log information associated with the user terminal 130. In some embodiments, the storage device 150 may store data and/or instructions that the server 110 may execute or use to perform exemplary methods described in the present disclosure.

In some embodiments, the storage device 150 may include a mass storage, removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

The positioning device 160 may determine information associated with an object, for example, one or more of the user terminal 130, or the vehicle 140 (e.g., a bicycle). For example, the positioning device 160 may determine a current time and a current location of the user terminal 130 and/or the vehicle 140. In some embodiments, the positioning device 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location (e.g., a departure location, a temporarily locked location, a destination, or a current location), a ride route, an elevation, a velocity, or an acceleration of the object, and/or a current time. The location may be in the form of coordinates, such as a latitude coordinate and a longitude coordinate, etc. The positioning device 160 may include one or more satellites, for example, a satellite 160-1, a satellite 160-2, and a satellite 160-3. The satellite 160-1 through 160-3 may determine the information mentioned above independently or jointly. The positioning device 160 may transmit the information mentioned above to the user terminal 130, or the vehicle 140 via the network 120.

The lock 170 may be configured to lock (or temporarily lock) and/or unlock the vehicle 140. For example, the lock 170 may include a mechanical lock or an electronic lock. The lock 170 and the vehicle 140 may be mechanically connected to each other. For example, the lock 170 may be mechanically mounted on the vehicle 140. Additionally or alternatively, the lock 170 and the vehicle 140 may be separated from each other, and the lock 170 may be installed on the vehicle 140 as an electronic device or locking application. In some embodiments, the lock 170 may be integrated into the vehicle 140.

The vehicle 140 and/or the lock 170 may communicate with the server 110, the network 120, the user terminal 130, and/or the positioning device 160. For example, the vehicle 140 and/or the lock 170 may transmit status information of the vehicle 140 to the server 110 via the network 120. The status information may include a location of the vehicle 140, a locked/unlocked status of the vehicle 140, battery power of the vehicle 140, operation information of the vehicle 140, or the like, or a combination thereof. As another example, the vehicle 140 may receive an instruction (e.g., an instruction to lock/unlock the vehicle 140) from the user terminal 130 and/or the server 110. As yet another example, the vehicle 140 may include a signal transmitter and a signal receiver (e.g., a GPS component of the vehicle 140) configured to communicate with the positioning device 160 for locating a position of the vehicle 140.

In some embodiments, one or more components of the vehicle sharing system 100 may access the data and/or instructions stored in the storage device 150 via the network 120. In some embodiments, the storage device 150 may be directly connected to the server 110 as a backend storage. In some embodiments, one or more components of the vehicle sharing system 100 (e.g., the server 110, the user terminal 130, or the vehicle 140) may have permissions to access the storage device 150. In some embodiments, one or more components of the vehicle sharing system 100 may read and/or modify the information related to the user, and/or the vehicle 140 when one or more conditions are met. For example, the server 110 may read and/or modify one or more users' information after a ride of the vehicle 140 is completed.

In some embodiments, the vehicle 140 may be a bicycle in the vehicle sharing system 100. In some embodiments, the information exchange between one or more components of the vehicle sharing system 100 may be initiated by way of launching the mobile application of the vehicle sharing service on a user terminal 130, requesting a vehicle service, requesting a temporarily locked service, aborting a temporarily locked service, or aborting a vehicle service.

In some embodiments, the vehicle sharing system 100 may further include at least one information exchange port (not shown in the figure) configured to communicate with at least one user terminal (e.g., the user terminal 130) via a network (e.g., the network 120) and in communication with at least one vehicle registered with the system via the network (e.g., the network 120).

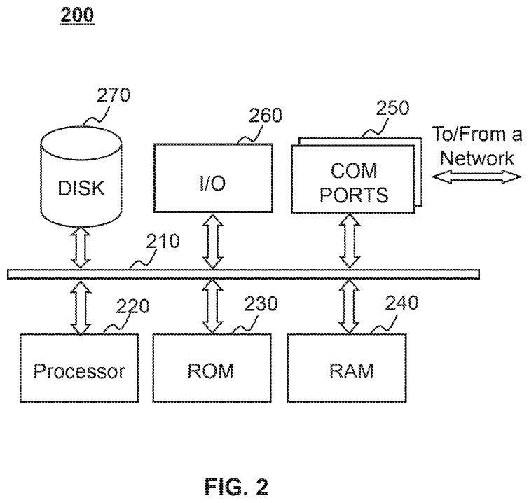

FIG. 2 a schematic diagram illustrating exemplary hardware and/or software components of a computing device 200 according to some embodiments of the present disclosure. The computing device 200 may be a special purpose computer. The computing device 200 may be used to implement any component of the vehicle sharing system 100 as described herein. For example, the processing engine 112 of the server 110, and/or the user terminal 130 may be implemented on the computing device 200, via its hardware, software program, firmware, or a combination thereof. Although only one such computer is shown for convenience, the computer functions related to the vehicle sharing service as described herein may be implemented in a distributed manner on a number of similar platforms to distribute the processing load.

The computing device 200, for example, may include COM ports 250 connected to and from a network (e.g., the network 120) connected thereto to facilitate data communications. The computing device 200 may also include a processor 220 for executing program instructions to perform the functions of the server 110 described herein. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or another type of non-transitory storage medium to be executed by the processor 220. The methods and/or processes of the present disclosure may be implemented as the program instructions. The computing device 200 also includes an I/O 260, supporting input/output between the computer, the user, and other components therein. The computing device 200 may also receive programming and data via network communications.

Merely for illustration, only one CPU and/or processor is described in the computing device 200. However, it should be noted that the computing device 200 in the present disclosure may also include multiple CPUs and/or processors, thus operation and/or method steps that are performed by one CPU and/or processor as described in the present disclosure may also be jointly or separately performed by the multiple CPUs and/or processors. For example, the CPU and/or processor of the computing device 200 may execute both step A and step B. As in another example, step A and step B may also be performed by two different CPUs and/or processors jointly or separately in the computing device 200 (e.g., the first processor executes step A and the second processor executes step B, or the first and second processors jointly execute steps A and B).

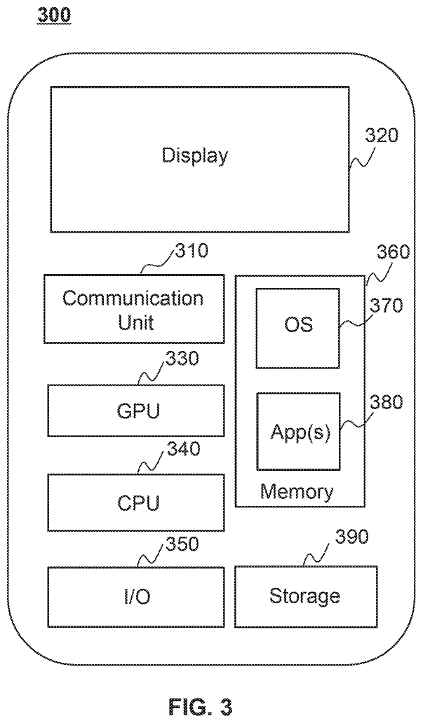

FIG. 3 is a schematic diagram illustrating exemplary hardware and/or software components of a mobile device 300 according to some embodiments of the present disclosure. As illustrated in FIG. 3, the mobile device 300 may include a communication module 310, a display 320, a graphic processing unit (GPU) 330, a processor 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™′ Windows Phone™) and one or more applications 380 may be loaded into the memory 360 from the storage 390 in order to be executed by the CPU 340. The applications 380 may include a browser or any other suitable apps for transmitting, receiving and presenting information relating to the status of the vehicle 140 (e.g., a ride status of the vehicle 140, a temporarily locked status of the vehicle 140, a location of the vehicle 140) from the server 110. User interactions with the information stream may be achieved via the I/O 350 and provided to the server 110 and/or other components of the vehicle sharing system 100 via the network 120. In some embodiments, a user may borrow (or rent) a vehicle via the mobile device 300. The user may also control the lock of the vehicle via the mobile device 300. For example, the user may input an instruction to temporarily close the lock or open the lock of the vehicle 140 via the mobile device 300.

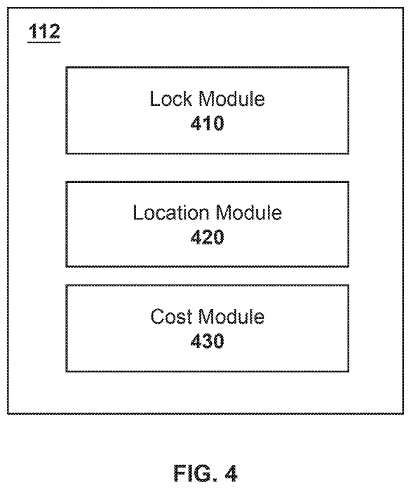

FIG. 4 is a block diagram illustrating an exemplary processing engine according to some embodiments of the present disclosure. The processing engine 112 may include a lock module 410, a location module 420, and a cost module 430.

The lock module 410 may determine a primary authorization command and create a record of a mission to authorize the user to use the vehicle in the storage device 150 or a local storage medium of the processing engine 112. The primary authorization command may refer to a permission for a user to use a vehicle in the vehicle sharing system 100 according to a request to use a vehicle.

In some embodiments, the lock module 410 may determine the primary authorization command based on the identifier data of the user and the identifier data of the vehicle. In some embodiments, the lock module 410 may determine whether the identifier data of the user and/or the identifier data of the vehicle satisfy a first authorization condition. Upon a determination that the identifier data of the user and/or the identifier data of the vehicle satisfy the first authorization condition, the lock module 410 may determine the primary authorization command and create a mission of the use of the vehicle. In some embodiments, the first authorization condition may include that an identification (ID) of the vehicle (or the lock of the vehicle) obtained by the user via scanning the QR code of the vehicle (and/or the lock of the vehicle) is the same as an identification of the vehicle (or the lock of the vehicle) stored in a storage device (e.g., the storage device 150), a password inputted by the user via the user terminal 130 is the same as a password of the vehicle (or the lock of the vehicle) stored in the storage device (e.g., storage device 150), the user pays a deposit in his/her user account, the user account has a balance, a credit rating of the user is good, the vehicle is in an available status, or the like, or any combination thereof. As used herein, a vehicle in an available status may refer to that the vehicle may be ready for a user to use.

In some embodiments, the user may initiate a request to use a vehicle by searching a vehicle near the location of the user via the user terminal 130. The user terminal 130 may transmit the request to use a vehicle to the server 110 for searching for vehicles near the location of the user terminal 130. For example, the server 110 may determine one or more available vehicles near the location of the user terminal 130 in response to the request to use a vehicle and transmit information relating to the determined one or more vehicles to the user terminal 130. The user terminal 130 may receive input from the user indicating a selected vehicle from the vehicles displayed on the user terminal 130, which may be transmitted to the server 110. As another example, the server 110 may determine an available vehicle near the location of the user terminal 130 randomly in response to the request to use a vehicle and transmit information relating to the determined vehicle to the user terminal 130. The lock module 410 may then determine the primary authorization command based on identifier data of the user and the identifier data of the determined vehicle.

After determining the authorization command, the lock module 410 may store the primary authorization command corresponding to the user in a storage device lock module 410 of the vehicle sharing system 100. The processing engine 112 may establish a connection between the user and the vehicle and store the connection in the storage device.

The lock module 410 may determine a primary enabling signal based on the primary authorization command. The primary enabling signal may include one or more instructions configured to control the status of the lock of the vehicle. For example, the primary enabling signal including an instruction to convert the lock of the vehicle from a second status into a first status may be transmitted to the lock of the vehicle to enable a use of the vehicle. The first status of the lock may be that the lock is open, and the second status of the lock may be that the lock is closed. In this situation, the vehicle may be in a ride status. The ride status of the vehicle may refer to that the lock of the vehicle is in the first status according to the request to use the vehicle.

The location module 420 may determine a first location based on a primary request signal. The processing engine 112 may first receive a primary request of a vehicle sharing service from the user terminal 130, and then generate a user interface configured to display a cost of the vehicle sharing service on a screen of the user terminal via wireless communications. The first location may be where a user terminal (e.g., the user terminal 130) sends the primary request signal, i.e., where a mission of using the vehicle starts. In some embodiments, the first location may be where a user requests for a service (e.g., a vehicle sharing service). For example, a lock of a vehicle may be converted from the second status into the first status to enable the use of the vehicle at the first location based on a request to use the vehicle. In some embodiments, the first location may include the country, the city, the street, and/or the longitudinal and latitudinal coordinates of the place where the user starts to use the vehicle.

The location module 420 may determine a second location based on a secondary request signal. The second location may be where the user terminal (e.g., the user terminal 130) sends the secondary request signal, i.e., where the mission of using the vehicle is temporarily paused. For example, the lock of the vehicle may be converted from the first status into the second status to disable the use of the vehicle at the second location without terminating the mission of using the vehicle based on a request to temporarily close the lock of the vehicle, and/or the lock of the vehicle may be converted from the second status into the first status to enable the use of the vehicle at the second location based on a request to abort the request to temporarily close the lock of the vehicle.

The location module 420 may determine a third location based on an aborting signal. The third location may be where a user terminal (e.g., the user terminal 130) sends the aborting signal. In some embodiments, the third location may be where a user terminate a service (e.g., a vehicle sharing service) so that the mission of the use of the vehicle ends. For example, the lock of the vehicle may be converted from the first status into the second status to disable the use of the vehicle at the third location based on a request to return the vehicle.

The cost module 430 may determine a first cost related to the first location and the second location. The first cost may refer to a fee that the user needs to pay when the user riding from the first location to the second location.

The cost module 430 may determine the first cost based on information related to the ride from the first location to the second location, such as a riding distance, a riding duration time, the first location, the second location, a start time, and an end time. As used herein, the riding distance may refer to an actual distance that a vehicle travels from the first location to the second location. The riding duration time may refer to the time that a user spend when riding from the first location to the second location. The start time may refer to a specific time of sending the primary request signal (e.g., the request to use the vehicle). The end time may refer to a specific time of sending the secondary request signal (e.g., the request to temporarily close the lock of the vehicle). The first cost may be determined based on one or more computer-implemented rules. For example, the cost module 430 may determine the first cost by multiplying the riding distance by a first rate (e.g., a cost per mile). As another example, the cost module 430 may determine the first cost by multiplying the riding time by a second rate (e.g., a cost per minute). As still another example, the cost module 430 may determine the first cost by determining a sum of a product of the riding distance and the first rate and a product of the riding duration time and the second rate.

In some embodiments, the first cost may be determined by adding a surcharge. The surcharge may include fees relating to riding distances, fees relating to riding duration time, fees for night riding, fees for peak-hour riding, fees for long distance riding, or the like, or any combination thereof. The fee relating to riding duration time may be a fee depending on the time the ride spend. For example, assuming that the time that the ride spent is less than 10 minutes, the fee relating to riding duration time may be a fixed price. When the time that the ride spent is more than 10 minutes, the fee relating to riding duration time may be increased depending on the time that the ride spend. The fee relating to the peak-hour riding may be a fee depending on the time the ride start. For example, assuming that the time that the ride started is peak hours (e.g., 8:00-9:00, 17:00-18:00, etc.), the fee relating to peak-hours may be added to the first cost.

The cost module 430 may determine a second cost related to the secondary request signal. The second cost may refer to a fee that the user needs to pay when the user temporarily locking a vehicle at the second location. The cost module 430 may determine the second cost based on information related to the temporarily locking of the vehicle at the second location, such as a temporarily locking duration time, the second location, a specific time of sending the secondary request signal (e.g., the request to temporarily close the lock of the vehicle, the request to abort the request to temporarily close the lock of the vehicle). As used herein, the temporarily locking duration time may refer to a time that a vehicle is locked at the second location. The second cost may be determined based on one or more computer-implemented rules. For example, the cost module 430 may determine the second cost by multiplying the temporarily locking duration time at second location by a third rate (e.g., a cost per minute). The cost module 430 may store the second cost in a storage device (e.g., the storage device 150) of the vehicle sharing system 100.

The cost module 430 may determine a third cost related to the second location and the third location. The third cost may refer to a fee that the user needs to pay when the user riding from the second location to the third location. The cost module 430 may determine a sum cost based on the first cost, the second cost, and the third cost. The sum cost may be refer to a total fee that the user needs to pay when using the vehicle. In some embodiments, the processing engine 112 may determine the sum cost by determining a sum of the first cost, the second cost, and the third cost.

In some embodiments, the processing engine 112 determine an indicator related to the sum cost on the user interface of the user terminal 130. In some embodiments, the user terminal 130 may display the sum cost on the user interface in the form of text, audio, graph, video, or the like, or any combination thereof. For example, the user terminal 130 may broadcast the sum cost. As another example, the processing engine 112 may send a message including the sum cost to the user terminal 130.

It should be noted that the descriptions above in relation to processing engine 112 is provided for the purposes of illustration, and not intended to limit the scope of the present disclosure. For persons having ordinary skills in the art, various variations and modifications may be conducted under the guidance of the present disclosure. For example, the processing engine 112 may further include a storage module facilitating data storage. However, those variations and modifications do not depart the scope of the present disclosure.

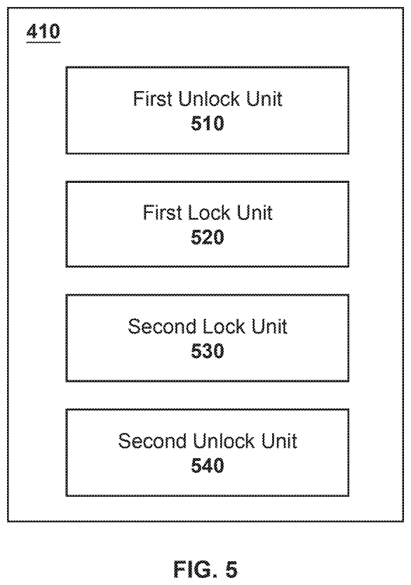

FIG. 5 is a block diagram illustrating an exemplary lock module according to some embodiments of the present disclosure. The lock module may be the lock module 410, which may include a first unlock unit 510, a first lock unit 520, a second lock unit 530, and a second unlock unit 540.

The first unlock unit 510 may be configured to obtain and verify a request, from a user of a user terminal, to use a vehicle registered with the server 110, thereby start a mission of vehicle sharing service to use the vehicle by a user. The first unlock unit 510 may open a lock of the vehicle if the request to use the vehicle satisfies the condition for using the vehicle. In some embodiments, the first unlock unit 510 may obtain the request to use the vehicle 140 from one or more components (e.g., the server 110, the user terminal 130) of the vehicle sharing system 100. In some embodiments, the verification of the request to use the vehicle may include: whether an identification (ID) of the vehicle 140 or the lock 170 obtained by scanning the QR code of the vehicle 140 and/or the lock 170 through a mobile application of the user terminal 130 or a camera of the user terminal 130 is the same as an identification of the vehicle 140 or the lock 170 stored in the storage device 150; whether a password inputted by a user via the user terminal 130 is the same as the password of the vehicle 140 stored in the storage device 150; whether a user pays a deposit in his/her user account stored in the storage device 150; whether a user account stored in the storage device 150 has a balance; whether a credit rating of a user stored in the storage device 150 is good, or the like, or any combination thereof. In some embodiments, if the request to use the vehicle satisfies the condition for using the vehicle, an instruction to open the lock of the vehicle may be transmitted to the lock 170 to open the lock of the vehicle 140 based on the request to use the vehicle.

The first lock unit 520 may be configured to obtain and verify a request, from a user of a user terminal, to return a vehicle and thereby completed and terminate the mission of service to use the vehicle. The first lock unit 520 may close a lock of the vehicle if the request to return the vehicle satisfies the condition for returning the vehicle. In some embodiments, the first lock unit 510 may obtain the request to return the vehicle 140 from one or more components (e.g., the server 110, the user terminal 130) of the vehicle sharing system 100. In some embodiment, the verification of the request to return the vehicle may include: whether the user pays for the use of the vehicle, upon a determination that the user pays for the use of the vehicle, the first lock unit 520 may determine that the request to return the vehicle may satisfy the condition for returning the vehicle, and thereby terminating the mission of vehicle using service. In some embodiments, if the request to return the vehicle satisfies the condition for returning the vehicle, an instruction to close the lock of the vehicle may be transmitted to the lock 170 to close the lock of the vehicle based on the request to return the vehicle.

The second lock unit 530 may be configured to obtain a request to temporarily close a lock of a vehicle. In some embodiments, the request to temporarily close the lock of the vehicle may be verified before the second lock unit 530 temporarily close the lock of the vehicle. The second lock unit 530 may close the lock of the vehicle without terminating the mission of vehicle using service if the request to temporarily close the lock of the vehicle satisfies the condition for temporarily locking the vehicle. In some embodiments, the second lock unit 530 may obtain the request to temporarily close the lock of the vehicle from one or more components (e.g., the user terminal 130) of the vehicle sharing system 100. In some embodiments, the verification of the request to temporarily close the lock of the vehicle may include: whether the mobile application through which the request to temporarily close the lock of the vehicle was sent is the same as the mobile application through which the request to use the vehicle was sent. Upon a determination that the mobile application through which the request to temporarily close the lock of the vehicle was sent is the same as the mobile application through which the verified request to use the vehicle was sent, the second lock unit 530 may determine that the request to temporarily close the lock of the vehicle may satisfy the condition for temporarily locking the vehicle. In some embodiments, if the request to temporarily close the lock of the vehicle satisfies the condition for temporarily locking the vehicle, an instruction to close the lock of the vehicle may be transmitted to the lock 170 to close the lock of the vehicle based on the request to temporarily close the lock of the vehicle, without terminating the mission of vehicle using service. In some embodiments, LEDs of the vehicle 140 may display that the vehicle is in a temporarily locked status. In some embodiments, a voice reminding such as “this vehicle cannot be used” may be generated to remind other users that the vehicle is in a temporarily locked status.

The second unlock unit 540 may be configured to obtain a request to abort the request to temporarily close the lock of the vehicle and open the lock of the vehicle. In some embodiments, the request to abort the request to temporarily close the lock of the vehicle may be verified before the second unlock unit 540 open the lock of the vehicle. The second unlock unit 540 may open the lock of the vehicle if the request to abort the request to temporarily close the lock of the vehicle satisfies the condition for aborting the request to temporarily close the lock of the vehicle. In some embodiments, the request to abort the request to temporarily close the lock of the vehicle may be obtained from one or more components (e.g., the user terminal 130) of the vehicle sharing system 100. In some embodiments, the verification of the request to abort the request to temporarily close the lock of the vehicle may include: whether the mobile application through which the request to abort the request to temporarily close the lock of the vehicle was sent is the same as the mobile application through which the request to temporarily close the lock of the vehicle was sent. Upon a determination that the mobile application through which the request to abort the request to temporarily close the lock of the vehicle was sent is the same as the mobile application through which the request to temporarily close the lock of the vehicle was sent, the second unlock unit 540 may determine that the request to abort the request to temporarily close the lock of the vehicle may satisfy the condition for aborting the request to temporarily lock the vehicle. The verification of the request to abort the request to temporarily close the lock of the vehicle may also include: whether an identification (ID) of the vehicle 140 or the lock 170 obtained by scanning the QR code of the vehicle 140 and/or the lock 170 through a mobile application of the user terminal 130 or a camera of the user terminal 130 is the same as an identification of the vehicle 140 or the lock 170 stored in the storage device 150. Upon a determination that the identification (ID) of the vehicle 140 or the lock 170 obtained by scanning the QR code of the vehicle 140 and/or the lock 170 through the mobile application of the user terminal 130 or the camera of the user terminal 130 is the same as an identification of the vehicle 140 or the lock 170, the second unlock unit 540 may determine that the request to abort the request to temporarily close the lock of the vehicle may satisfy the condition for aborting the request to temporarily close the lock of the vehicle. The verification of the request to abort the request to temporarily close the lock of the vehicle may further include: whether a password inputted by a user via the user terminal 130 is the same as the password of the vehicle 140 stored in the storage device 150, whether a user pays a deposit in his/her user account stored in the storage device 150, whether a user account stored in the storage device 150 has a balance, whether a credit rating of a user stored in the storage device 150 is good, or the like, or any combination thereof. In some embodiments, if the request to abort the request to temporarily close the lock of the vehicle satisfies the condition for aborting the request to temporarily close the lock of the vehicle, an instruction to open the lock of the vehicle may be transmitted to the lock 170 to open the lock of the vehicle based on the request to abort the request to temporarily close the lock of the vehicle. In some embodiments, LEDs of the vehicle 140 may display that the vehicle is in an end temporarily locked status. In some embodiments, a voice reminding such as “your car is here” may be generated to help the user find the vehicle.

It should be noted that the descriptions above in relation to processing engine 112 is provided for the purposes of illustration, and not intended to limit the scope of the present disclosure. For persons having ordinary skills in the art, various variations and modifications may be conducted under the guidance of the present disclosure. For example, the lock module 410 may further include a storage unit facilitating data storage. However, those variations and modifications do not depart the scope of the present disclosure.

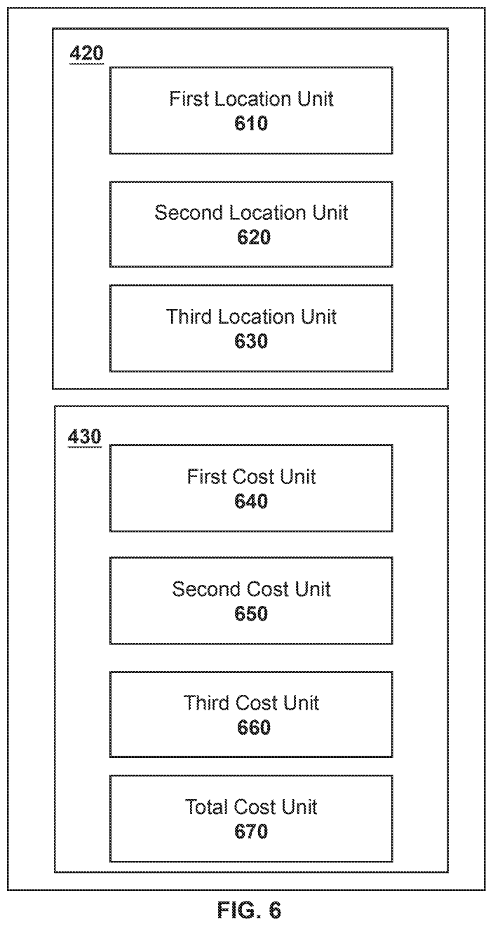

FIG. 6 is a block diagram illustrating an exemplary location module and an exemplary cost module according to some embodiments of the present disclosure. The location module 420 may include a first location unit 610, a second location unit 620, and a third location unit 630. The cost module 430 may include a first cost unit 640, a second cost unit 650, a third cost unit 660, and a total cost unit 670.

The first location unit 610 may be configured to obtain a request to use a vehicle and determine a first location based on the request to use the vehicle. In some embodiments, the request to use the vehicle may be obtained from one or more components (e.g., the server 110, the user terminal 130) of the vehicle sharing system 100. In some embodiments, a real time latitude and longitude coordinates of the first location may be obtained from the positioning device 160.

The second location unit 620 may be configured to obtain a request to temporarily close a lock of a vehicle and determine a second location based on the request to temporarily close the lock of the vehicle. In some embodiments, the request to temporarily close the lock of the vehicle may be obtained from one or more components (e.g., the server 110, the user terminal 130) of the vehicle sharing system 100. In some embodiments, a real time latitude and longitude coordinates of the second location may be obtained from the positioning device 160.

The third location unit 630 may be configured to obtain a request to return a vehicle and determine a third location based on the request to return the vehicle. In some embodiments, the request to return the vehicle may be obtained from one or more components (e.g., the server 110, the user terminal 130) of the vehicle sharing system 100. In some embodiments, a real time latitude and longitude coordinates of the third location may be obtained from the positioning device 160.

The first cost unit 640 may be configured to determine a first cost related to a ride from the first location to the second location. In some embodiments, a first riding distance may be determined based on a distance between the first location and the second location. The first cost may be determined by multiplying the first riding distance by a first rate (e.g., a cost per mile). In some embodiments, a first riding time may be determined based on the time of the ride from the first location to the second location. The first cost may be determined by multiplying the first riding time by a second rate (e.g., a cost per minute). In some embodiments, the first cost may be a sum of a product of the first riding distance and the first rate and a product of the first riding time and the second rate.

The second cost unit 650 may be configured to determine a second cost related to a temporarily locked status of the vehicle. In some embodiments, the second cost may be determined by multiplying the time of the temporarily locking at the second location by a third rate (e.g., a cost per minute).

The third cost unit 660 may be configured to determine a third cost related to a ride from the second location to the third location. In some embodiments, a second riding distance may be determined based on a distance between the second location and the third location. The third cost may be determined by multiplying the second riding distance by a first rate (e.g., a cost per mile). In some embodiments, a second riding time may be determined based on the time of the ride from the second location to the third location. The third cost may be determined by multiplying the second riding time by a second rate (e.g., a cost per minute). In some embodiments, the third cost may be a sum of a product of the second riding distance and the first rate and a product of the second riding time and the second rate.

The total cost unit 670 may be configured to determine a sum cost of the first cost, the second cost, and the third cost. In some embodiments, the sum cost of using the vehicle may be a sum of the first cost, the second cost, and the third cost.

It should be noted that the descriptions above in relation to processing engine 112 is provided for the purposes of illustration, and not intended to limit the scope of the present disclosure. For persons having ordinary skills in the art, various variations and modifications may be conducted under the guidance of the present disclosure. For example, the location module 420 and/or the cost module 430 may further include a storage unit facilitating data storage. However, those variations and modifications do not depart the scope of the present disclosure.

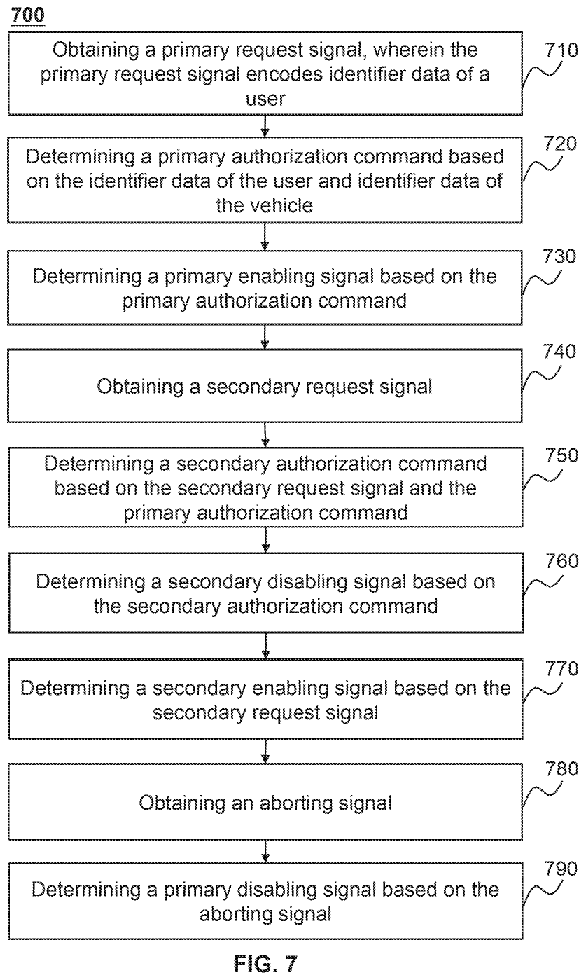

FIG. 7 is a flowchart illustrating an exemplary process for providing vehicle service to a user according to some embodiments of the present disclosure. The process 700 may be executed by the vehicle sharing system 100. For example, the process 700 may be implemented as a set of instructions stored in the storage ROM 230 or RAM 240. The processor 220 and/or the modules in FIG. 4 may execute the set of instructions, and when executing the instructions, the processor 220 and/or the modules may be configured to perform the process 700. The operations of the illustrated process presented below are intended to be illustrative. In some embodiments, the process 700 may be accomplished with one or more additional operations not described and/or without one or more of the operations discussed. Additionally, the order in which the operations of the process 700 as illustrated in FIG. 7 and described below is not intended to be limiting.

In 710, the processing engine 112 (e.g., the lock module 410) may obtain a primary request signal. The primary request signal may be a request for a service (e.g. a vehicle sharing service). For example, the primary request signal may be a request to use a vehicle in the vehicle sharing service. In some embodiments, the primary request signal may include identifier data of a user, a real-time position of a user, a specific time of the sending of the primary request signal, or the like, or any combination thereof. The identifier data of the user may include a user name, an identification (ID) of a user, a telephone number of a user, a type of a user (e.g., an annual card user, a quarterly card user, or a monthly card user), usage records of a user (e.g., riding time, riding miles), a credit rating of a user, a user account balance, or the like, or any combination thereof. In some embodiments, the primary request signal may further include an identifier data of a vehicle. The identifier data of the vehicle may include an identification (ID) of a vehicle, a service condition of a vehicle (e.g., in an available status, in a maintenance status), a position of a vehicle, a type of a vehicle (e.g., a bicycle, a motor bicycle, an electric bicycle), or the like, or any combination thereof. In some embodiments, the vehicle and/or a lock of the vehicle may be identified with a unique symbol. The unique symbol may include a bar code, a quick response (QR) code, a serial number including letters and/or digits, or the like, or any combination thereof. In some embodiments, the identifier data of the vehicle (e.g. the identification (ID) of the vehicle) may be obtained by scanning the QR code of the vehicle through a mobile application or a camera of the user terminal 130.

In some embodiments, the processing engine 112 may obtain the primary request signal from one or more components of the vehicle sharing system 100 (e.g., the user terminal 130) via the network 120. In some embodiments, the user terminal 130 may establish a communication (e.g., wireless communication) with the server 110, for example, through an application (e.g., the application 380 in FIG. 3) installed in the user terminal 130. In some embodiments, the application may be associated with a service (e.g., a vehicle sharing service). In some embodiments, the user may log into the application and initiate a service request via the application. For example, the user may initiate a request to use a vehicle by searching a vehicle near the location of the user. As another example, the user may initiate the request to use a vehicle through scanning a QR code of the vehicle via the application or a camera of the user terminal 130. In some embodiments, the application installed in the user terminal 130 may direct the user terminal 130 to monitor, continuously or periodically, service requests from the user, and automatically transmit the service requests to the processing engine 112 via the network 120.

In 720, the processing engine 112 (e.g., the lock module 410) may determine a primary authorization command and create a record of a mission to authorize the user to use the vehicle in the storage device 150 or a local storage medium of the processing engine 112. The primary authorization command may refer to a permission for a user to use a vehicle in the vehicle sharing system 100 according to a request to use a vehicle.

In some embodiments, the processing engine 112 may determine the primary authorization command based on the identifier data of the user and the identifier data of the vehicle. In some embodiments, the processing engine 112 may determine whether the identifier data of the user and/or the identifier data of the vehicle satisfy a first authorization condition. Upon a determination that the identifier data of the user and/or the identifier data of the vehicle satisfy the first authorization condition, the processing engine 112 may determine the primary authorization command and create a mission of the use of the vehicle. In some embodiments, the first authorization condition may include that an identification (ID) of the vehicle (or the lock of the vehicle) obtained by the user via scanning the QR code of the vehicle (and/or the lock of the vehicle) is the same as an identification of the vehicle (or the lock of the vehicle) stored in a storage device (e.g., the storage device 150), a password inputted by the user via the user terminal 130 is the same as a password of the vehicle (or the lock of the vehicle) stored in the storage device (e.g., storage device 150), the user pays a deposit in his/her user account, the user account has a balance, a credit rating of the user is good, the vehicle is in an available status, or the like, or any combination thereof. As used herein, a vehicle in an available status may refer to that the vehicle may be ready for a user to use.

In some embodiments, the user may initiate a request to use a vehicle by searching a vehicle near the location of the user via the user terminal 130. The user terminal 130 may transmit the request to use a vehicle to the server 110 for searching for vehicles near the location of the user terminal 130. For example, the server 110 may determine one or more available vehicles near the location of the user terminal 130 in response to the request to use a vehicle and transmit information relating to the determined one or more vehicles to the user terminal 130. The user terminal 130 may receive input from the user indicating a selected vehicle from the vehicles displayed on the user terminal 130, which may be transmitted to the server 110. As another example, the server 110 may determine an available vehicle near the location of the user terminal 130 randomly in response to the request to use a vehicle and transmit information relating to the determined vehicle to the user terminal 130. The processing engine 112 may then determine the primary authorization command based on identifier data of the user and the identifier data of the determined vehicle.

After determining the authorization command, the processing engine 112 may store the primary authorization command corresponding to the user in a storage device (e.g., the storage device 150) of the vehicle sharing system 100. The processing engine 112 may establish a connection between the user and the vehicle and store the connection in the storage device.

In 730, the processing engine 112 (e.g., the lock module 410) may determine a primary enabling signal based on the primary authorization command. The primary enabling signal may include one or more instructions configured to control the status of the lock of the vehicle. For example, the primary enabling signal including an instruction to convert the lock of the vehicle from a second status into a first status may be transmitted to the lock of the vehicle to enable a use of the vehicle. The first status of the lock may be that the lock is open, and the second status of the lock may be that the lock is closed. In this situation, the vehicle may be in a ride status. The ride status of the vehicle may refer to that the lock of the vehicle is in the first status according to the request to use the vehicle.

In 740, the processing engine 112 (e.g., the lock module 410) may obtain a secondary request signal. The secondary request signal may be different from the primary request signal. In some embodiments, the secondary request signal may include a request to temporarily close (lock) a lock of the vehicle and/or a request to abort the request to temporarily close the lock of the vehicle.

In some embodiments, the processing engine 112 may obtain the request to temporarily close the lock of the vehicle from the user terminal 130 when the user wants to leave the vehicle for a time period while using the vehicle. The processing engine 112 may obtain the request to abort the request to temporarily close the lock of the vehicle from the user terminal 130 when the user comes back to the vehicle and continue to use the vehicle. In some embodiments, the processing engine 112 may obtain the secondary request signal from one or more components of the vehicle sharing system 100 (e.g., the user terminal 130) via the network 120.

In 750, the processing engine 112 (e.g., the lock module 410) may determine a secondary authorization command, without terminating the mission of the use of the vehicle, based on the secondary request signal and the primary authorization command. The secondary authorization command may refer to a permission for a user to temporarily close the lock of the vehicle in the vehicle sharing system 100 according to a request to temporarily close the lock of the vehicle. The secondary authorization command may also refer to a permission for a user to abort the request to temporarily close the lock of the vehicle in the vehicle sharing system 100 according to a request to abort the request to temporarily close the lock of the vehicle.

In some embodiments, the processing engine 112 may determine the secondary authorization command based on the secondary request signal and the primary authorization command. In some embodiments, the processing engine 112 may determine whether the secondary request signal satisfy a second authorization condition. Upon a determination that the secondary request signal satisfy the second authorization condition, the processing engine 112 may determine the secondary authorization command. In some embodiments, the second authorization condition may include that the secondary request signal may be sent via a user terminal 130 authenticated according to the primary authorization command.

In 760, the processing engine 112 (e.g., the lock module 410) may determine a secondary disabling signal based on the secondary authorization command. The secondary disabling signal may include one or more instructions to control the status of the lock of the vehicle. For example, the secondary disabling signal including an instruction to convert the lock of the vehicle into the second status may be transmitted to the lock of the vehicle to disable a use of the vehicle. In this situation, the vehicle may be in a temporarily locked status without terminating the mission of the user of the vehicle. The temporarily locked status of the vehicle may refer to that the lock of the vehicle is in the second status according to the request to temporarily close the lock of the vehicle.

In some embodiments, the vehicle may include a reminding signal generator. In some embodiment, the reminding signal generator may include a light-emitting diode. The reminding signal generator may be configured to generate a reminding signal related to the status of the vehicle. For example, the reminding signal generator may generate a reminding signal to remind other users that the vehicle is in a temporarily locked status. Merely for illustration purposes, the reminding signal generator may generate a voice reminding such as “this car cannot be used”.

In 770, the processing engine 112 (e.g., the lock module 410) may determine a secondary enabling signal based on the secondary request signal to resume the mission of the user of the vehicle. The secondary enabling signal may include one or more instructions to control the status of the lock of the vehicle. For example, the secondary enabling signal including an instruction to convert the lock of the vehicle into the first status may be transmitted to the lock of the vehicle to enable a use of the vehicle. In this situation, the vehicle may be in an end temporarily locked status. The end temporarily locked status of the vehicle may refer to that the lock of the vehicle is in the first status according to the request to abort the request to temporarily close the lock of the vehicle.

In some embodiments, the alert signal generator of the vehicle may generate a reminding signal to help the user find the vehicle. Merely for illustration purposes, the reminding signal generator may generate a voice reminding such as “your car is here”.

In 780, the processing engine 112 (e.g., the lock module 410) may obtain an aborting signal. The aborting signal may be a request to terminate a service. In some embodiments, the aborting signal may be a request to return the vehicle.

In some embodiments, the processing engine 112 may obtain the request to return the vehicle from the user terminal 130 when the user finishes the ride and wants to return the vehicle. In some embodiments, the processing engine 112 may obtain the aborting signal from one or more components of the vehicle sharing system 100 (e.g., the user terminal 130) via the network 120.

In 790, the processing engine 112 (e.g., the lock module 410) may determine a primary disabling signal based on the aborting signal. The primary disabling signal may include one or more instructions to control the status of the lock of the vehicle. For example, the primary disabling signal including an instruction to convert the lock of the vehicle into the second status may be transmitted to the lock of the vehicle to disable the use of the vehicle. In this situation, the vehicle may be in the available status. The available status of the vehicle may refer to that the vehicle may be ready for a next user.

In some embodiments, the processing engine 112 may determine the primary disabling signal based on a tertiary authorization command. The tertiary authorization command may refer to a permission for a user to return a vehicle in the vehicle sharing system 100 according to a request to return a vehicle. In some embodiments, the processing engine 112 may determine the tertiary authorization command based on the aborting signal. For example, the processing engine 112 may determine whether the user pays for the use of the vehicle. Upon a determination that the user pays for the use of the vehicle, the processing engine 112 may determine the tertiary authorization command.

In some embodiments, after the primary disabling signal is determined, the processing engine 112 may disconnect the connection between the user and the vehicle, and release the primary authorization command corresponding to the user stored in the storage device (e.g., the storage device 150).

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more other optional steps (e.g., a storing step) may be added elsewhere in the exemplary process 700. In the storing step, the processing engine 112 may store information and/or data associated with the vehicle and the user (e.g., the identifier data of the user, the identifier data of the vehicle) in a storage device (e.g., the storage device 150) disclosed elsewhere in the present disclosure. In some embodiments, one or more steps may be omitted. For example, step 770 may be omitted. The processing engine 112 may obtain a request to return the vehicle instead of a request to abort the request to temporarily close the lock of the vehicle if the user do not want to continue to use the vehicle after sending a request to temporarily close the lock of the vehicle.

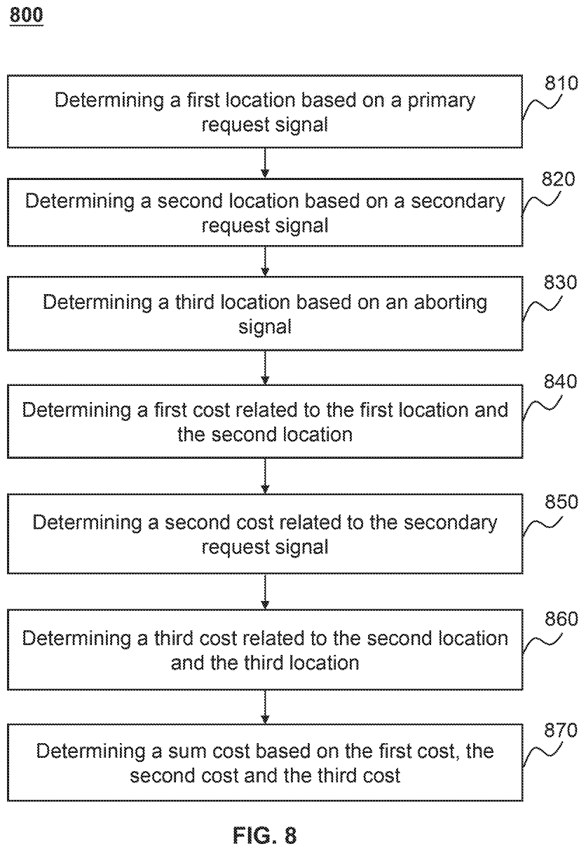

FIG. 8 is a flowchart illustrating an exemplary process for billing users in the vehicle sharing system 100 according to some embodiments of the present disclosure. The process 800 may be executed by the vehicle sharing system 100. For example, the process 800 may be implemented as a set of instructions stored in the storage ROM 230 or RAM 240. The processor 220 and/or the modules in FIG. 4 may execute the set of instructions, and when executing the instructions, the processor 220 and/or the modules may be configured to perform the process 800. The operations of the illustrated process presented below are intended to be illustrative. In some embodiments, the process 800 may be accomplished with one or more additional operations not described and/or without one or more of the operations discussed. Additionally, the order in which the operations of the process 800 as illustrated in FIG. 8 and described below is not intended to be limiting.

In 810, the processing engine 112 (e.g., the location module 420) may determine a first location based on a primary request signal. The processing engine 112 may first receive a primary request of a vehicle sharing service from the user terminal 130, and then generate a user interface configured to display a cost of the vehicle sharing service on a screen of the user terminal via wireless communications. The first location may be where a user terminal (e.g., the user terminal 130) sends the primary request signal, i.e., where a mission of using the vehicle starts. In some embodiments, the first location may be where a user requests for a service (e.g., a vehicle sharing service). For example, a lock of a vehicle may be converted from the second status into the first status to enable the use of the vehicle at the first location based on a request to use the vehicle. In some embodiments, the first location may include the country, the city, the street, and/or the longitudinal and latitudinal coordinates of the place where the user starts to use the vehicle.

In some embodiments, the processing engine 112 may obtain position information (e.g., GPS information) of the user terminal 130 which indicates a current location of the user terminal 130 from one or more components (e.g., the user terminal 130, the positioning device 160) of the vehicle sharing system 100 at a certain time interval (e.g., 1 second, 10 seconds, 1 minutes, etc.), in real time or substantially in real-time. Further, the processing engine 112 may store the position information in a storage device (e.g., the storage device 150) disclosed elsewhere in the present disclosure.

In 820, the processing engine 112 (e.g., the location module 420) may determine a second location based on a secondary request signal. The second location may be where the user terminal (e.g., the user terminal 130) sends the secondary request signal, i.e., where the mission of using the vehicle is temporarily paused. For example, the lock of the vehicle may be converted from the first status into the second status to disable the use of the vehicle at the second location without terminating the mission of using the vehicle based on a request to temporarily close the lock of the vehicle, and/or the lock of the vehicle may be converted from the second status into the first status to enable the use of the vehicle at the second location based on a request to abort the request to temporarily close the lock of the vehicle.

In some embodiments, the processing engine 112 may obtain the second location from one or more components (e.g., the user terminal 130, the positioning device 160) of the vehicle sharing system 100 as described elsewhere in the present disclosure.

In 830, the processing engine 112 (e.g., the location module 420) may determine a third location based on an aborting signal. The third location may be where a user terminal (e.g., the user terminal 130) sends the aborting signal. In some embodiments, the third location may be where a user terminate a service (e.g., a vehicle sharing service) so that the mission of the use of the vehicle ends. For example, the lock of the vehicle may be converted from the first status into the second status to disable the use of the vehicle at the third location based on a request to return the vehicle.

In some embodiments, the processing engine 112 may obtain the third location from one or more components (e.g., the user terminal 130, the positioning device 160) of the vehicle sharing system 100 as described elsewhere in the present disclosure.

In 840, the processing engine 112 (e.g., the cost module 430) may determine a first cost related to the first location and the second location. The first cost may refer to a fee that the user needs to pay when the user riding from the first location to the second location.

The processing engine 112 may determine the first cost based on information related to the ride from the first location to the second location, such as a riding distance, a riding duration time, the first location, the second location, a start time, and an end time. As used herein, the riding distance may refer to an actual distance that a vehicle travels from the first location to the second location. The riding duration time may refer to the time that a user spend when riding from the first location to the second location. The start time may refer to a specific time of sending the primary request signal (e.g., the request to use the vehicle). The end time may refer to a specific time of sending the secondary request signal (e.g., the request to temporarily close the lock of the vehicle). The first cost may be determined based on one or more computer-implemented rules. For example, the processing engine 112 may determine the first cost by multiplying the riding distance by a first rate (e.g., a cost per mile). As another example, the processing engine 112 may determine the first cost by multiplying the riding time by a second rate (e.g., a cost per minute). As still another example, the processing engine 112 may determine the first cost by determining a sum of a product of the riding distance and the first rate and a product of the riding duration time and the second rate.

In some embodiments, the first cost may be determined by adding a surcharge. The surcharge may include fees relating to riding distances, fees relating to riding duration time, fees for night riding, fees for peak-hour riding, fees for long distance riding, or the like, or any combination thereof. The fee relating to riding duration time may be a fee depending on the time the ride spend. For example, assuming that the time that the ride spent is less than 10 minutes, the fee relating to riding duration time may be a fixed price. When the time that the ride spent is more than 10 minutes, the fee relating to riding duration time may be increased depending on the time that the ride spend. The fee relating to the peak-hour riding may be a fee depending on the time the ride start. For example, assuming that the time that the ride started is peak hours (e.g., 8:00-9:00, 17:00-18:00, etc.), the fee relating to peak-hours may be added to the first cost.

The processing engine 112 may store the first cost in a storage device (e.g., the storage device 150) of the vehicle sharing system 100.

In 850, the processing engine 112 (e.g., the cost module 430) may determine a second cost related to the secondary request signal. The second cost may refer to a fee that the user needs to pay when the user temporarily locking a vehicle at the second location. The processing engine 112 may determine the second cost based on information related to the temporarily locking of the vehicle at the second location, such as a temporarily locking duration time, the second location, a specific time of sending the secondary request signal (e.g., the request to temporarily close the lock of the vehicle, the request to abort the request to temporarily close the lock of the vehicle). As used herein, the temporarily locking duration time may refer to a time that a vehicle is locked at the second location. The second cost may be determined based on one or more computer-implemented rules. For example, the processing engine 112 may determine the second cost by multiplying the temporarily locking duration time at second location by a third rate (e.g., a cost per minute). The processing engine 112 may store the second cost in a storage device (e.g., the storage device 150) of the vehicle sharing system 100.

In 860, the processing engine 112 (e.g., the cost module 430) may determine a third cost related to the second location and the third location. The third cost may refer to a fee that the user needs to pay when the user riding from the second location to the third location. The determination of the third cost may be similar to that of the first cost as described in connection with operation 840, and the detailed descriptions thereof are not repeated here. The processing engine 112 may store the third cost in a storage device (e.g., the storage device 150) of the vehicle sharing system 100.

In 870, the processing engine 112 (e.g., the cost module 430) may determine a sum cost based on the first cost, the second cost, and the third cost. The sum cost may be refer to a total fee that the user needs to pay when using the vehicle. In some embodiments, the processing engine 112 may determine the sum cost by determining a sum of the first cost, the second cost, and the third cost.

In some embodiments, the processing engine 112 determine an indicator related to the sum cost on the user interface of the user terminal 130. In some embodiments, the user terminal 130 may display the sum cost on the user interface in the form of text, audio, graph, video, or the like, or any combination thereof. For example, the user terminal 130 may broadcast the sum cost. As another example, the processing engine 112 may send a message including the sum cost to the user terminal 130.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 800. In the storing step, the processing engine 112 may store information and/or data associated with the locations (e.g., the first location, the second location, the third location) and/or the costs (e.g., the first cost, the second cost, and the third cost) in a storage device (e.g., the storage device 150) disclosed elsewhere in the present disclosure. In some embodiments, one or more steps may be omitted. For example, step 830 and step 860 may be omitted. The processing engine 112 may obtain a request to return the vehicle instead of a request to abort the request to temporarily close the lock of the vehicle if the user do not want to continue to use the vehicle after sending a request to temporarily close the lock of the vehicle. Accordingly, the sum cost may only include the first cost and the second cost.

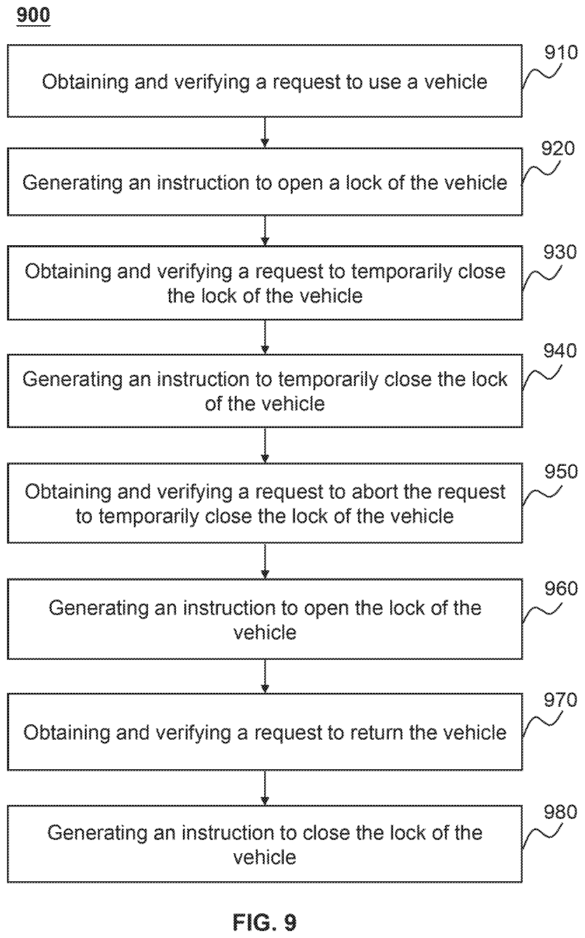

FIG. 9 is a flowchart illustrating an exemplary process for providing vehicle service to a user according to some embodiments of the present disclosure.

In 910, a request to use a vehicle may be obtained and verified. In some embodiments, the request to use the vehicle (e.g., the vehicle 140) may be obtained from one or more components (e.g., the server 110, the user terminal 130) of the vehicle sharing system 100. In some embodiments, the verification of the request to use the vehicle may include: whether an identification (ID) of the vehicle 140 or the lock 170 obtained by scanning the QR code of the vehicle 140 and/or the lock 170 through a mobile application of the user terminal 130 or a camera of the user terminal 130 is the same as an identification of the vehicle 140 or the lock 170 stored in the storage device 150; whether a password inputted by a user via the user terminal 130 is the same as the password of the vehicle 140 stored in the storage device 150; whether a user pays a deposit in his/her user account stored in the storage device 150; whether a user account stored in the storage device 150 has a balance; whether a credit rating of a user stored in the storage device 150 is good, or the like, or any combination thereof.

In 920, a lock of the vehicle may be opened if the request to use the vehicle satisfies the condition for using the vehicle. In some embodiments, if the request to use the vehicle satisfies the condition for using the vehicle, an instruction to open the lock of the vehicle may be transmitted to the lock 170 to open the lock of the vehicle 140 based on the request to use the vehicle.

In 930, a request to temporarily close the lock of the vehicle may be obtained. In some embodiments, the request to temporarily close the lock of the vehicle may be obtained from one or more components (e.g., the user terminal 130) of the vehicle sharing system 100. In some embodiments, the request to temporarily close the lock of the vehicle may be verified before the processing engine 112 temporarily close the lock of the vehicle. In some embodiments, the verification of the request to temporarily close the lock of the vehicle may include: whether the mobile application through which the request to temporarily close the lock of the vehicle was sent is the same as the mobile application through which the request to use the vehicle was sent. Upon a determination that the mobile application through which the request to temporarily close the lock of the vehicle was sent is the same as the mobile application through which the verified request to use the vehicle was sent, the processing engine 112 may determine that the request to temporarily close the lock of the vehicle may satisfy the condition for temporarily locking the vehicle.

In 940, a lock of the vehicle may be temporarily closed if the request to temporarily close the lock of the vehicle satisfies the condition for temporarily locking the vehicle. In some embodiments, if the request to temporarily close the lock of the vehicle satisfies the condition for temporarily locking the vehicle, an instruction to close the lock of the vehicle may be transmitted to the lock 170 to close the lock of the vehicle based on the request to temporarily close the lock of the vehicle.

In some embodiments, LEDs of the vehicle 140 may display that the vehicle is in a temporarily locked status. In some embodiments, a voice reminding such as “this vehicle cannot be used” may be generated to remind other users that the vehicle is in a temporarily locked status.

In 950, a request to abort the request to temporarily close the lock of the vehicle may be obtained. In some embodiments, the request to abort the request to temporarily close the lock of the vehicle may be obtained from one or more components (e.g., the user terminal 130) of the vehicle sharing system 100. In some embodiments, the request to abort the request to temporarily close the lock of the vehicle may be verified before the processing engine 112 open the lock of the vehicle. In some embodiments, the verification of the request to abort the request to temporarily close the lock of the vehicle may include: whether the mobile application through which the request to abort the request to temporarily close the lock of the vehicle was sent is the same as the mobile application through which the request to temporarily close the lock of the vehicle was sent. Upon a determination that the mobile application through which the request to abort the request to temporarily close the lock of the vehicle was sent is the same as the mobile application through which the request to temporarily close the lock of the vehicle was sent, the processing engine 112 may determine that the request to abort the request to temporarily close the lock of the vehicle may satisfy the condition for aborting the request to temporarily lock the vehicle. The verification of the request to abort the request to temporarily close the lock of the vehicle may also include: whether an identification (ID) of the vehicle 140 or the lock 170 obtained by scanning the QR code of the vehicle 140 and/or the lock 170 through a mobile application of the user terminal 130 or a camera of the user terminal 130 is the same as an identification of the vehicle 140 or the lock 170 stored in the storage device 150. Upon a determination that the identification (ID) of the vehicle 140 or the lock 170 obtained by scanning the QR code of the vehicle 140 and/or the lock 170 through the mobile application of the user terminal 130 or the camera of the user terminal 130 is the same as an identification of the vehicle 140 or the lock 170, the processing engine 112 may determine that the request to abort the request to temporarily close the lock of the vehicle may satisfy the condition for aborting the request to temporarily close the lock of the vehicle. The verification of the request to abort the request to temporarily close the lock of the vehicle may further include: whether a password inputted by a user via the user terminal 130 is the same as the password of the vehicle 140 stored in the storage device 150, whether a user pays a deposit in his/her user account stored in the storage device 150, whether a user account stored in the storage device 150 has a balance, whether a credit rating of a user stored in the storage device 150 is good, or the like, or any combination thereof.

In 960, the lock of the vehicle may be opened if the request to abort the request to temporarily close the lock of the vehicle satisfies the condition for aborting the request to temporarily close the lock of the vehicle. In some embodiments, if the request to abort the request to temporarily close the lock of the vehicle satisfies the condition for aborting the request to temporarily close the lock of the vehicle, an instruction to open the lock of the vehicle may be transmitted to the lock 170 to open the lock of the vehicle based on the request to abort the request to temporarily close the lock of the vehicle.

In some embodiments, LEDs of the vehicle 140 may display that the vehicle is in an end temporarily locked status. In some embodiments, a voice reminding such as “your car is here” may be generated to help the user find the vehicle.

In 970, a request to return the vehicle may be obtained and verified. In some embodiments, the request to return the vehicle may be obtained from one or more components (e.g., the server 110, the user terminal 130) of the vehicle sharing system 100. In some embodiment, the verification of the request to return the vehicle may include: whether the user pays for the use of the vehicle, upon a determination that the user pays for the use of the vehicle, the processing engine 112 may determine that the request to return the vehicle may satisfy the condition for returning the vehicle.

In 980, the lock of the vehicle may be closed if the request to return the vehicle satisfies the condition for returning the vehicle. In some embodiments, if the request to return the vehicle satisfies the condition for returning the vehicle, an instruction to close the lock of the vehicle may be transmitted to the lock 170 to close the lock of the vehicle based on the request to return the vehicle.

In some embodiments, the request to return the vehicle may be close the lock 170. The verification of the request to return the vehicle may include: whether the lock 170 is successfully closed, upon a determination that the lock 170 is successfully closed, the processing engine 112 may determine that the request to return the vehicle may satisfy the condition for returning the vehicle.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure.

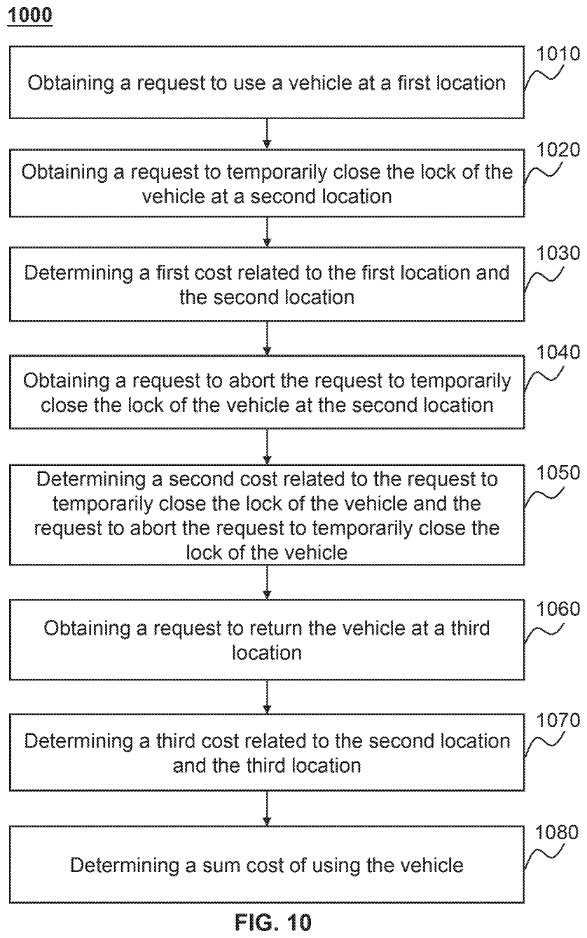

FIG. 10 is a flowchart illustrating an exemplary process for billing users in the vehicle sharing system 100 according to some embodiments of the present disclosure.

In 1010, a request to use a vehicle may be obtained at a first location. In some embodiments, the request to use the vehicle and the first location may be obtained from one or more components (e.g., the server 110, the user terminal 130, and the positioning device 160) of the vehicle sharing system 100.

In 1020, a request to temporarily close the lock of the vehicle may be obtained at a second location. In some embodiments, the request to temporarily close the lock of the vehicle and the second location may be obtained from one or more components (e.g., the server 110, the user terminal 130, and the positioning device 160) of the vehicle sharing system 100.

In 1030, a first cost related to the first location and the second location may be determined. In some embodiments, a first riding distance may be determined based on a distance between the first location and the second location. The first cost may be determined by multiplying the first riding distance by a first rate (e.g., a cost per mile). In some embodiments, a first riding time may be determined based on the time of the ride from the first location to the second location. The first cost may be determined by multiplying the first riding time by a second rate (e.g., a cost per minute). In some embodiments, the first cost may be a sum of a product of the first riding distance and the first rate and a product of the first riding time and the second rate.

In 1040, a request to abort the request to temporarily close the lock of the vehicle may be obtained at the second location. In some embodiments, the request to abort the request to temporarily close the lock of the vehicle may be obtained from one or more components (e.g., the server 110, the user terminal 130, and the positioning device 160) of the vehicle sharing system 100.

In 1050, a second cost related to the request to temporarily close the lock of the vehicle and the request to abort the request to temporarily close the lock of the vehicle may be determined. In some embodiments, the second cost may be determined by multiplying the time of the temporarily locking at the second location by a third rate (e.g., a cost per minute).

In 1060, a request to return the vehicle may be obtained at a third location. In some embodiments, the request to return the vehicle and the third location may be obtained from one or more components (e.g., the server 110, the user terminal 130, and the positioning device 160) of the vehicle sharing system 100.

In 1070, a third cost related to the second location and the third location may be determined. The determination of the third cost may be similar to that of the first cost as described in connection with operation 1030, and the detailed descriptions thereof are not repeated here.

In 1080, a sum cost of using the vehicle may be determined. In some embodiments, the sum cost may be a sum of the first cost, the second cost, and the third cost.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for operating a lock in a vehicle, comprising:
at least one information exchange port configured to communicate with at least one user terminal via a network and in communication with at least one vehicle registered with the system via a network;
at least one non-transitory storage medium including a set of instructions; and
at least one processor in communication with the at least one information exchange port and the at least one non-transitory storage medium, wherein when executing the set of instructions, the at least one processor is directed to operate logic circuits in the at least one processor to:
establish a first wireless communication with a user terminal and a second wireless communication with a lock mounted on the vehicle registered with the system;
obtain, from the user terminal, a primary request signal related to use of the vehicle by a user associated with the user terminal, wherein the primary request signal includes identifier data of the user terminal;
obtain identifier data of the vehicle;
determine a primary authorization command based on the identifier data of the user terminal and the identifier data of the vehicle, and create a record of a mission to authorize the user to use the vehicle in the at least one non-transitory storage medium;
based on the primary authorization command, send a primary enabling signal to the vehicle to open a lock mounted on the vehicle;
obtain, from the user terminal, a first secondary request signal including a temporary locking signal; and
based on the first secondary request signal, determine a secondary disabling signal to lock the lock of the vehicle without terminating the mission stored in the at least one non-transitory storage medium.

2. The system of claim 1, further comprising:
obtain, from the user terminal, a second secondary request signal including a temporary unlocking signal;
based on the second secondary request signal, determine a secondary enabling signal to unlock the lock and resume the mission stored in the at least one non-transitory storage medium;
based on an aborting signal sent from the user terminal, determine a primary disabling signal to lock the vehicle to disable the use of the vehicle; and
in response to the primary disabling signal, terminate and release the mission stored in the at least one non-transitory storage medium.

3. The system of claim 1, wherein the primary request signal further includes the identifier data of the vehicle, and
the identifier data of the vehicle is obtained based on a quick-response code of the vehicle.

4. The system of claim 1, wherein the vehicle includes a reminding signal generator, and the secondary disabling signal is further configured to operate the reminding signal generator to generate a reminding signal related to a temporary locking status of the vehicle.

5. The system of claim 1, wherein the vehicle includes a reminding signal generator, and the secondary enabling signal is further configured to operate the reminding signal generator to generate a reminding signal related to an unlocking status of the vehicle.

6. The system of claim 4, wherein the reminding signal generator includes a light-emitting diode.

7. The system of claim 1, wherein to determine the secondary disabling signal based on the first secondary request signal, the at least one processor is further directed to operate the logic circuits to:
determine a secondary authorization command based on the first secondary request signal and the primary authorization command; and
determine the secondary disabling signal based on the secondary authorization command.

8. The system of claim 2, wherein to determine the secondary enabling signal based on the second secondary request signal, the at least one processor is further directed to operate the logic circuits to:
determine a secondary authorization command based on the second secondary request signal and the primary authorization command; and
determine the secondary enabling signal based on the secondary authorization command.

9-21. (canceled)

22. A vehicle sharing method with temporarily locking function, comprising:
obtaining and verifying a request to use a vehicle, if the request to use the vehicle satisfies a condition for using the vehicle, opening a lock of the vehicle;
obtaining a request to temporarily close the lock of the vehicle and closing the lock of the vehicle;
obtaining a request to abort the request to temporarily close the lock of the vehicle and opening the lock of the vehicle; and
obtaining and verifying a request to return the vehicle, if the request to return the vehicle satisfies a condition for returning the vehicle, closing the lock of the vehicle.

23. The method of claim 22, wherein obtaining the request to temporarily close the lock of the vehicle further comprises:
verifying the request to temporarily close the lock of the vehicle, and
if the request to temporarily close the lock of the vehicle satisfies a condition for temporarily locking the vehicle, closing the lock of the vehicle.

24. The method of claim 22, wherein obtaining the request to abort the request to temporarily close the lock of the vehicle further comprises:
verifying the request to abort the request to temporarily close the lock of the vehicle, and
if the request to abort the request to temporarily close the lock of the vehicle satisfies a condition for aborting the request to temporarily close the lock of the vehicle, opening the lock of the vehicle.

25. The method of claim 22, wherein the request to temporarily close the lock of the vehicle is initiated from a user terminal.

26. The method of claim 22, wherein the request to abort the request to temporarily close the lock of the vehicle is initiated from a user terminal.

27. The method of claim 22, wherein an alert signal generator in the vehicle generates a reminding signal to indicate that the vehicle is in a temporarily locked status when the vehicle is in the temporarily locked status.

28. The method of claim 22, wherein an alert signal generator in the vehicle generates a reminding signal to indicate that the vehicle is in an end temporarily locked status when the vehicle is in the end temporarily locked status.

29. A method for determining a cost related to use of a vehicle in a vehicle sharing system with temporarily locking function, comprising:
obtaining a request to use a vehicle at a first location;
obtaining a request to temporarily close the lock of the vehicle at a second location;
determining a first cost related to a ride mode from the first location to the second location;
obtaining a request to abort the request to temporarily close the lock of the vehicle;
determining a second cost related to a temporarily locked mode;
obtaining a request to return the vehicle at a third location;
determining a third cost related to the ride mode from the second location to the third location; and
determining a sum cost of using the vehicle, wherein the sum cost is a sum of the first cost, the second cost, and the third cost.

30. The method of claim 29, wherein determining the second cost related to the temporarily locked mode comprises:
determining a time of the temporarily locking of the vehicle at the second location; and
determining the second cost related to the temporarily locked mode based on the time of the temporarily locking of the vehicle at the second location and a third rate.

31. (canceled)

32. A vehicle sharing device with temporarily locking function, comprising at least one processor, wherein the at least one processor is directed to cause the vehicle sharing device to perform a method in claim 22.

33. A non-transitory computer readable medium, comprising at least one set of instructions, wherein when executed by one or more processors of a computing device, the at least one set of instructions causes the computing device to perform a method in claim 22.

34. (canceled)

35. A device for determining a cost related to use of a vehicle in a vehicle sharing system with temporarily locking function, comprising at least one processor, wherein the at least one processor is directed to cause the device to perform a method in claim 29.

36. (canceled)
